(19) United States
(12) Patent Application Publication
(10) Pub. No.: US 2014/0012473 A1
(43) Pub. Date: Jan. 9, 2014

(54) CLUTCH ARRANGEMENT FOR A GEARBOX AND METHOD TO CONTROL A SEPARATING CLUTCH

(71) Applicant: ZF Friedrichshafen AG, Friedrichshafen (DE)

(72) Inventors: Christoph OMMER, Friedrichshafen (DE); Alexander JUNGABERLE, Schlier (DE)

(21) Appl. No.: 13/927,362

(22) Filed: Jun. 26, 2013

(30) Foreign Application Priority Data
Jul. 5, 2012 (DE) 10 2012 211 675.3

(51) Int. Cl. F16D 25/063

(52) U.S. Cl. CPC F16D 25/063
USPC 701/68; 192/66.3

(57) ABSTRACT

A clutch arrangement for a transmission which comprises a wet separating clutch having a clutch housing, in which a clutch piston separates an interior space from a pressure chamber. The separating clutch is engaged by pressurizing the pressure chamber with an actuating pressure so that the clutch piston moves into an actuation position and, as a result, two clutch halves, located in the interior space and surrounded by fluid, frictionally engage one another. So as to reliably engage the separating clutch without impairing the surrounding components with the fluid, the actuating pressure includes at least one compensation pressure portion that corresponds to the counter pressure depending on the fluid located in the interior space opposing the clutch piston during transfer into the actuation position. A method of controlling a separating clutch, and a computer program product and a data medium incorporating the computer program product are also disclosed.

This application claims priority from German patent application serial no. 10 2012 211 675.3 filed Jul. 5, 2012.

### FIELD OF THE INVENTION

The invention relates to a clutch arrangement for a transmission, particularly for a hybrid transmission, comprising a wet separating clutch having a closed clutch housing, in which a guided movable clutch piston separates an interior space from a pressure chamber, wherein the separating clutch can be transferred into an engaged state, in that, by pressurizing the pressure chamber with an actuating pressure, the clutch piston moves into an actuation position, and as a result, two clutch halves, which are located in the interior space and surrounded by fluid, and that otherwise can rotate with respect to each other, are brought into contact in frictional engagement with each other. The invention further relates to a method for controlling a separating clutch, and a computer program product and a data medium having the computer program product.

### BACKGROUND OF THE INVENTION

Hybrid transmissions represent a hybrid of conventional transmissions, in which typically a hybrid module with an electric machine is connected upstream of the respective conventional transmission in the framework of the design of a parallel hybrid. Here, typically a clutch arrangement having a hydraulic separating clutch is used, by means of which an internal combustion engine, upstream of the hybrid module, and the electric machine can be coupled together, such that in conjunction with a startup clutch in the transmission, the most varied operating states can be implemented. Thus, by appropriate control of the separating clutches, hybrid functions can be implemented, such as a vehicle power supply, engine start-stop function, electric travel or maneuvering, boosting using the electric machine, and recuperation. The respective separating clutch is implemented either as a dry clutch, with the advantage of higher attainable friction coefficients and lower drag torque in the disengaged state, or as a wet clutch, whereby, by means of cooling, higher power consumption and energy absorption is possible, and thus, a more compact design is possible. In the case of a design as a wet separating clutch, the clutch must be positioned within the transmission so that splashing fluid does not cause problems for surrounding components, such as the electric machine in particular. Here, an established possibility is to accommodate a wet clutch completely in a closed clutch housing.

DE 10 2006 056 512 A1 discloses a clutch arrangement of a hybrid transmission, in which a wet separating clutch is disposed within an electric machine. This wet separating clutch, which is implemented as a wet multi-disk clutch, has a closed clutch housing in which a movable clutch piston is guided, and in doing so, separates a pressure chamber located in the rear region thereof from an interior space. Here, clutch halves in the form of outer disks and inner disks, which form a multi-disk packet and are provided alternating in the axial direction, and which can rotate with respect to each other, are accommodated in the interior space. The outer disks are connected to the surrounding clutch housing in a rotationally fixed manner, whereas the inner disks are disposed on a common disk carrier, which is connected via an interposed torsion damper to a rotor of the electric machine, and in the further course to a conventional transmission part of the hybrid transmission. In contrast, the clutch housing and thus, also the outer disks of the wet clutch are coupled to the output side of an internal combustion engine, upstream of the hybrid drive, so that the wet multi-disk clutch, in an engaged state, connects the output side of the internal combustion engine to the rotor of the electric machine, and thus also to the subsequent transmission part. For engaging the separating clutch, the pressure chamber is pressurized with an actuating pressure so that the clutch piston moves into an actuation position, and in doing so, the multi-disk packet is pressed together such that the outer disks and the inner disks are brought into contact in frictional engagement with each other, and as a result the clutch housing and the disk carrier are coupled together. As a result, the multi-disk packet located in the interior space is surrounded by fluid, particularly an oil-like liquid, for cooling and lubrication, where the fluid is supplied and again drained using appropriate openings in the clutch housing.

### SUMMARY OF THE INVENTION

Based on this prior art, the problem addressed by the present invention is to provide a clutch arrangement for a transmission, in which surrounding components of a wet separating clutch are not impaired by the fluid, and, however, which can implement a reliable engagement of the separating clutch.

This problem is solved with a clutch arrangement according to the invention with the characterizing features thereof. With respect to a method for controlling a separating clutch, the problem is solved by the technical teaching of the invention. With respect to a computer program product corresponding hereto and a storage medium containing this product, according to the invention is described below.

According to the invention, a clutch arrangement of a transmission comprises a wet separating clutch having a closed clutch housing, in which a guided movable piston clutch separates an interior space from a pressure chamber. Here, the separating clutch can be transferred into an engaged state, in which, by pressurizing the pressure chamber with an actuating pressure, the clutch piston is moved into actuating position, and as a result, two clutch halves that otherwise can rotate with respect to each other are brought into contact in frictional engagement. Here, the clutch halves that can rotate with respect to each other, are located in the interior space and surrounded by fluid.

As set forth in the invention, the wet separating clutch is particularly a wet multi-disk clutch, the clutch halves of which are formed by inner disks and outer disks that are disposed alternating in the axial direction, and are connected to an inner disk carrier, or respectively to an outer disk carrier in a rotationally fixed manner. Using the disk carrier, the clutch halves are then connected to components to be coupled together. An outer disk carrier is however preferably implemented by the surrounding, closed clutch housing. Additionally, the clutch housing, in the region of the interior space, has at least one inlet and at least one outlet, using which, fluid is conveyed through the interior space for lubricating and cooling the clutch halves. The fluid is further preferably an oil-like liquid, which is suitable for cooling and lubricating. Finally, the clutch housing is designed particularly as a closed torus, whereby a compact clutch housing can be implemented.

The invention comprises the technical teaching that the actuating pressure, with which the pressure chamber is pressurized for transferring the clutch piston into the actuation position thereof, contains at least one compensation pressure portion which corresponds to a counter pressure depending on the fluid located in the interior space and countering the clutch piston during transfer into the actuation position. This compensation pressure portion is determined by a model and is subsequently included in the determination of the actuating pressure, with which the pressure chamber is subsequently pressurized for engaging the separating clutch. In other words, a portion of the actuating pressure serves to compensate a counter pressure, which counters the clutch piston during transfer of the clutch piston into the actuation position thereof, and this portion of pressure has its source in the flow-through of the interior space with the cooling and lubricating fluid.

This fluid must be supplied to, and again discharged from, the interior space of the closed clutch housing, which, during movement of the clutch piston in the direction of the clutch halves, generates a corresponding resistance opposing the clutch piston, and causes a pressure decrease upon actuating the clutch piston. By compensating this pressure portion, the wet separating clutch can be reliably controlled, and at the same time, the clutch halves can be enclosed in a closed clutch housing, so that surrounding components are not impaired by sprayed fluid. Additionally, other constructive measures to be performed with respect to the counter pressure can be omitted. In this respect, the reliable control of the wet separating clutch can also be implemented with low production expenditure.

According to one embodiment of the invention, the actuating pressure comprises a housing compensation pressure portion, which corresponds to a counter pressure caused by displacing the fluid during movement of the clutch piston, and additionally contains a dynamic compensation pressure portion, via which a pressure reduction is compensated, which occurs at the start of the pressurization of the pressure chamber and depends on the fluid in the interior space. Because of the closed clutch housing, during movement of the clutch piston, the counter pressure that depends on the fluid displacement, and the pressure drop, occur, caused by increased piston movements. These two effects can now be compensated for using the compensation pressure portions, such that the clutch piston can first advance the separating clutch toward the touch point thereof without problems, and then, using further target pressure portions of the actuating pressure, acts on the clutch halves depending on the respective operating point. A “touch point” of the separating clutch is understood here to mean the point at which the two clutch halves contact each other, without torque transfer.

In a further development of the invention, the actuating pressure additionally comprises at least one minimum filling pressure portion, a load-dependent target pressure portion and a rotational speed-dependent target pressure portion. In the scope of the invention, a minimum filling pressure portion is understood to be a pressure portion, with which the clutch halves are brought into a contact in a load-free state in the case of an absence of counter pressure acting on the clutch piston, thus defining the touch point of the clutch. Using the minimum filling pressure portion, the touch point would represent the case of an absence of the encapsulation of the clutch halves in a closed clutch housing.

In contrast, using the load-dependent target pressure portion, a torque-based degree of engagement of the separating clutch can be defined, thus, an additional pressure portion is applied to the clutch piston, so that the clutch halves are pressed together beyond the touch point, and the resulting frictional engagement allows the transfer of appropriate torque. Using the speed-dependent target pressure portion, additionally, a speed differential can be set between the clutch halves, thus, starting from the load-dependent target pressure portion, an appropriate pressure offset can be added, by means of which a certain slipping of the wet separating clutch can be implemented. As a result, the transfer of undesired effects via the separating clutch can at the least be reduced.

According to the invention, the actuating pressure contains at least one further situation-dependent pressure offset. By means of this pressure offset, or the further pressure portions, further operating-dependent situations can be taken into account, so that a coupling of the two components using the wet separating clutch is improved. By means of the pressure offset or the further pressure offset, the other pressure portions of the actuating pressure can be appropriately superimposed.

According to a further advantageous embodiment of the invention, a rotor of an electric machine can be coupled to an internal combustion engine using the separating clutch, wherein the separating clutch with the clutch housing thereof is disposed located within the rotor. Accordingly, the clutch arrangement is part of a hybrid transmission, in which, using the wet separating clutch, a power flow can be produced between the internal combustion engine and the rotor of the electric machine and thus in an electric drive train so that using the clutch arrangement, a hybrid of a downstream conventional transmission can be implemented. The arrangement of the wet separating clutch within the rotor of the electric machine allows a compact arrangement of the separating clutch, wherein in addition, due to the accommodation in the closed clutch housing, impairment of the surrounding electric machine can be eliminated. Here a hybrid is designed according to a type of parallel hybrid.

According to the invention, the dynamic compensation pressure portion is also determined depending on a filling of the pressure chamber of the clutch housing. The dynamic compensation pressure portion is calculated using a parameter, which also influences the value of the pressure decrease. Consequently, the pressure decrease is reliably compensated for.

The solution according to the invention can also be embodied as a computer program product, which, when executing on a processor of a control device of the transmission, instructs the processor according to the software to perform the assigned method steps according to the subject matter of the invention.

In this context, the subject matter of the invention also includes a computer readable medium, on which a retrievable computer program product as described above is stored.

The invention is not limited to the stated combination of features of the embodiments described herein. Moreover, the possibility arises of combining individual features, which arise from the following description of an embodiment, or directly from the drawings.

### BRIEF DESCRIPTION OF THE DRAWINGS

Further advantageous embodiments of the invention arise from the subsequent description of a preferred embodiment of the invention with reference to the figures represented in the drawings. Shown are:

FIG. 1 a schematic view of a clutch arrangement according to a preferred embodiment of the invention;

FIG. 2 a pictorial representation of a composition of an actuating pressure, which is applied to a clutch piston of the clutch arrangement from FIG. 1; and

FIG. 3 a graphical representation of a dynamic compensation pressure portion of the actuating pressure from FIG. 2.

### DETAILED DESCRIPTION OF THE PREFERRED EMBODIMENTS

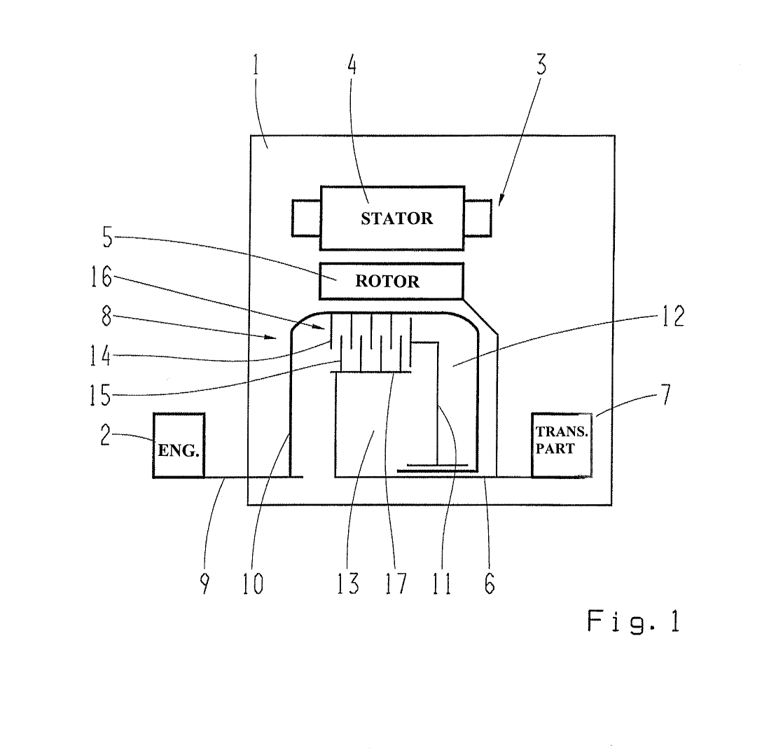

FIG. 1 shows a schematic view of a clutch arrangement according to a preferred embodiment of the invention. This clutch arrangement is part of a hybrid transmission 1, which—shown only schematically—is connected downstream of an internal combustion engine 2 of a vehicle for the translation of a rotational movement of the internal combustion engine 2. The hybrid transmission 1 has a hybrid module having an integrated electric machine 3, which comprises a locationally fixed stator 4 and a rotatable rotor 5 located radially within. The rotor 5 is connected to a drive shaft 6 in a rotationally fixed manner, which in further course is connected—shown here in a highly schematic representation—to a conventional transmission part 7 of the hybrid transmission 1, having subsequent spur gear stages or planetary stages. Further, the rotor 5 can be coupled together with the drive shaft 6 via an upstream wet separating clutch 8, to an output shaft 9 of the internal combustion engine 2.

Corresponding to the connection possibilities via the wet separating clutch 8, a drive movement of the drive shaft 6 can therefore be implemented either via only the rotor 5 of the electric machine 3, or however, also by both the internal combustion engine 2 and the electric machine 3. In the latter case, rotational movement implemented via the internal combustion engine 2 and transferred by means of the output shaft 9, and the interposed separating clutch 8 to the drive shaft 6, is supported by the electric machine 3. Additionally, in slip mode of the internal combustion engine 2, that is, with a drive of the internal combustion engine 2 via the drive train of the motor vehicle, recuperation of energy is possible via the electric machine 3. Furthermore, to also implement a decoupling of the hybrid module having the electric machine 3 from the conventional transmission part 7, additionally, a further separating clutch can be provided between the drive shaft 6 and a transmission input of the transmission part 7.

As seen in FIG. 1, the wet separating clutch 8 is disposed within the electric machine 3, in that the clutch is located substantially axially at the height of the electric machine 3 and radially within the rotor 5. In order to avoid an impairment of the electric machine 3 in the process due to fluid of the wet separating clutch 8, the separating clutch 8 has a closed clutch housing 10 in the shape of a closed torus, which is connected to the output shaft 9 of the internal combustion engine 2 in a rotationally fixed manner. A clutch piston 11 is guided, axially movable in the clutch housing 10, wherein here, the clutch piston 11 separates a pressure chamber 12 located in the rear region thereof from a further interior space 13 of the clutch housing 10. In this interior space 13, two clutch halves are provided in the form of several outer disks 14 and several inner disks 15, that can rotate relative to each other, wherein the outer disks 14 and the inner disks 15 are disposed here alternating in the axial direction and together form a multi-disk packet 16, thus forming a separating clutch 8 implemented as a wet multi-disk clutch. Here the outer disks 14 are connected, radially outside, to the surrounding clutch housing 10 in a rotationally fixed manner, whereas the inner disks 15 are coupled, at the respective radial inside thereof, to a common disk carrier 17, which additionally is connected to the rotor 5 of the electric machine 3 in a rotationally fixed manner to the drive shaft 6.

During operation of the hybrid transmission 1, the interior space 13 of the clutch housing 10 is supplied, via inlet and outlet channels, presently not shown, with fluid for cooling and lubricating the multi-disk packet 16, wherein this fluid is an oil-like liquid, suitable for cooling and lubricating. An engagement of the separating clutch 8, and thus a coupling of the output shaft 9 to the drive shaft 6 and the rotor 5, can be initiated in that the pressure chamber 12 is pressurized with an actuating pressure 18, whereby the clutch piston 11 moves in the axial direction of the multi-disk packet 16, and in the process, brings the outer disks 14 and the inner disks 15 into frictionally engaging contact. As a consequence, a respective rotational movement is transmitted between the clutch housing 10 and the drive shaft 6 via the interposed multi-disk carrier 17.

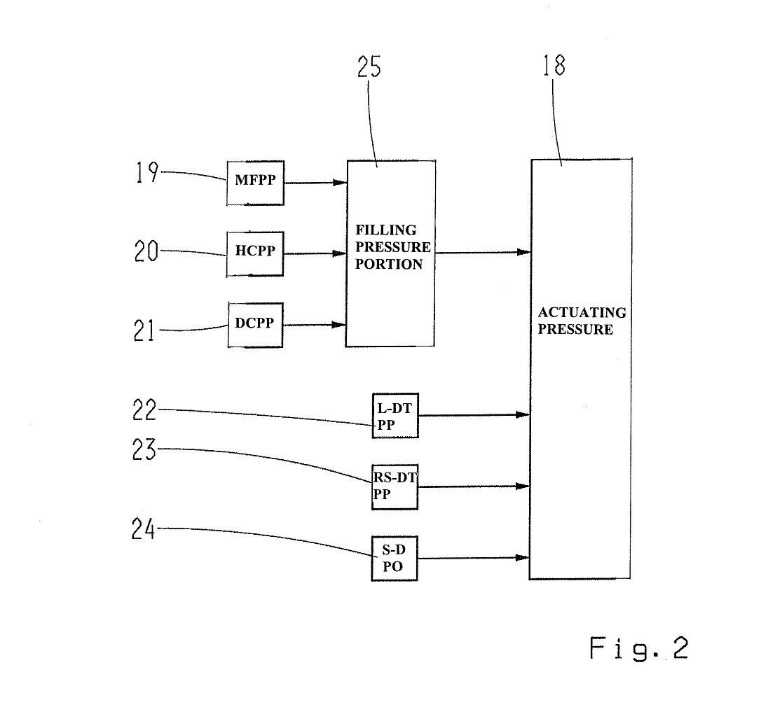

Due to the fluid located in the interior space 13 and surrounding the multi-disk packet 16, a resistance opposes the clutch piston 11 during the movement thereof into the actuation position that is compressing the multi-disk packet 16. In order to still ensure a reliable engagement of the wet separating clutch 8, the actuating pressure 18 is calculated in the scope of a model, and is comprised, as shown in FIG. 2, of several pressure portions; as can be seen, the actuating pressure 18 is comprised of several pressure portions 19 to 24. The pressure portions 19 to 21 form a filling pressure portion 25, wherein pressurization of the pressure chamber 12 with a pressure in the amount of this filling pressure portion 25 is represented as a touch point of the wet separating clutch 8. A touch point of the separating clutch 8 means that the outer disks 14 and the inner disks 15 come into contact in a load-free state, thus there is contact between the outer disks 14 and inner disks 15 without torque transfer. Here, the filling pressure portion 25 is comprised of a minimum filling pressure portion (MFPP) 19, a housing compensation pressure portion (HCPP) 20, and a dynamic compensation pressure portion (DCPP) 21. The housing compensation pressure portion 20 corresponds in the amount thereof to a counter pressure, which acts on the clutch piston 11 during transfer into the actuation position thereof due to the fluid located in the interior space 13. This is because, during the movement of the clutch piston 11 into the actuation position, the fluid flowing through the interior space 13 must be displaced into a drain, which creates a corresponding resistance for the clutch piston 11.

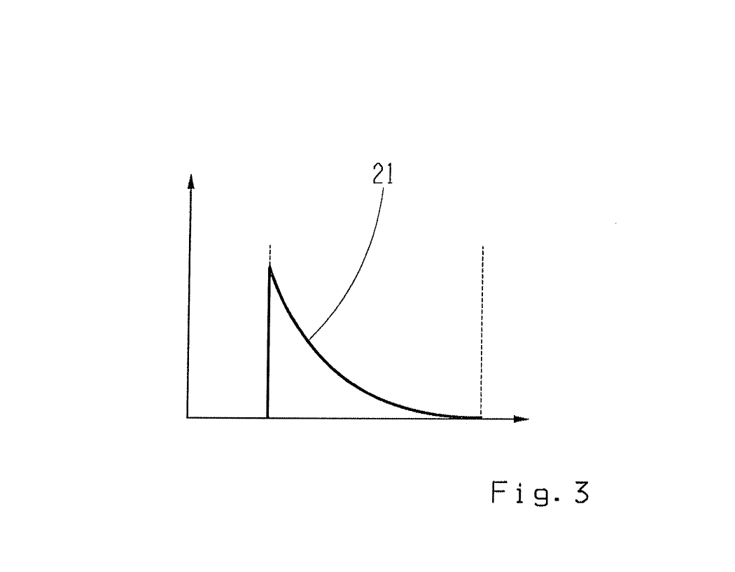

The dynamic compensation pressure portion 21 also takes into account a pressure decrease, which occurs at the start of filling the pressure chamber 12 due to the fluid located in the interior space 13. The graph in FIG. 3 shows a progression of this dynamic compensation pressure portion. As seen here, at the start of pressurizing the pressure chamber 12, a higher compensation pressure portion must be implemented, which decreases with increasing filling of the pressure chamber 12, and eventually reaches zero.

The two compensation pressure portions 20 and 21 are then combined with the minimum filling pressure portion 19 into the filling pressure portion 25. The minimum filling pressure portion 19 corresponds to a pressure which, in the absence of the clutch housing 10, and thus the omission of the counter pressures caused by the fluid in the interior space 13, would be sufficient for advancing the separating clutch 8 to the touch point thereof.

The thusly calculated filling pressure 25 is combined in the following with further pressure portions in the form of a load-dependent target pressure portion (L-DTPP) 22, a rotational speed-dependent target pressure portion (RS-DTPP) 23, and a further situation-dependent pressure offset (S-DPO) 24 for the final actuating pressure 18. The load-dependent target pressure portion 22 defines a torque-based degree of engagement of the separating clutch 8, that is, how strongly the outer disks 14 and inner disks 15 are pressed together by the clutch piston 11, in order to be able to transmit a corresponding torque due to the frictional engagement arising in the process. In contrast, a differential speed between the outer disks 14 and the inner disks 15 can be set using the speed-dependent target pressure portion 23. As a result, a defined slip of the separating clutch 8 can be specified, so that certain effects, for example rotational non-uniformities, are not transferred from the output shaft 9 to the drive shaft 6.

The further pressure offset 24 represents a situation-dependent pressure portion, via which a pressure defined by means of the remaining pressure portions can be increased or reduced in order to improve a coupling between the internal combustion engine 2 and the drive shaft 6, and the electric machine 3, at certain operating points of the hybrid transmission 1. Such a pressure offset 24 comes into play, for example, during shifting in the subsequent transmission part 7.

By means of the embodiment of a clutch arrangement according to the invention it is therefore possible, to simultaneously guarantee, with a compact arrangement of a wet separating clutch 8 within an electric machine 3 in a closed clutch housing 10, a reliable control of the separating clutch 8. Other than with the hybrid transmission 1, the teaching according to the invention can however also be used with a conventional transmission with a separating clutch having a closed clutch housing.

### REFERENCE CHARACTERS

1 hybrid transmission

2 internal combustion engine

3 electric machine

4 stator

5 rotor

6 drive shaft

7 transmission part

8 separating clutch

9 output shaft

10 clutch housing

11 clutch piston

12 pressure chamber

13 interior space

14 outer disks

15 inner disks

16 multi-disk packet

17 disk carrier

18 actuating pressure

19 minimum filling pressure portion

20 housing compensation pressure portion

21 dynamic compensation pressure portion

22 load-dependent target pressure portion

23 rotational speed-dependent target pressure portion

24 pressure offset

25 filling pressure

1-10. (canceled)

11. A clutch arrangement for a hybrid transmission (1), the clutch arrangement comprising:
a wet separating clutch (8) having an enclosed clutch housing (10) accommodating a guided movable clutch piston (11),
the clutch piston (11) separating an interior space (13) from a pressure chamber (12), the separating clutch (8) being transferable into an engaged state in which, due to pressurization of the pressure chamber (12) by an actuating pressure (18), the clutch piston (11) moves into an actuation position and, as a result, two clutch halves, which are located in the interior space (13) and surrounded by fluid and otherwise rotatable with respect to one another, are brought into frictional engagement with one another, and
the actuating pressure (18) comprises at least one compensation pressure portion (20, 21), which corresponds to a counter pressure depending on fluid located in the interior space (13) and opposing the clutch piston (11) during transfer into the actuation position.

12. The clutch arrangement according to claim 11, wherein the actuating pressure (18) comprises a housing compensation pressure portion (20), which corresponds to a counter pressure caused by displacing the fluid during movement of the clutch piston (11), and contains a dynamic compensation pressure portion (21), via which a pressure decrease, dependent on the fluid in the interior space (13) and occurring at the start of the pressurization of the pressure chamber (12), is compensated for.

13. The clutch arrangement according to claim 11, wherein the actuating pressure (18) additionally comprises at least the following pressure portions:
a minimum filling pressure portion (19), with which in an absence of counter pressure on the clutch piston (11), the clutch halves can be brought into in a load-free state;
a load-dependent target pressure portion (22), by which a torque-based degree of engagement of the separating clutch (8) is definable; and
a rotational speed-dependent target pressure portion (23) via which a differential speed can be set between the clutch halves.

14. The clutch arrangement according to claim 11, wherein the actuating pressure (18) comprises at least a further, situation-dependent offset pressure (24).

15. The clutch arrangement according to claim 11, wherein a rotor (5) of the electric machine (3) is couplable to an internal combustion engine (2) using the separating clutch (8), and
the separating clutch (8) is disposed with the clutch housing (10) thereof, located within the rotor (5).

16. A method for controlling a wet separating clutch (8) having an enclosed clutch housing (10), which is divided by a movable clutch piston (11) into a pressure chamber (12) and an interior space (13), the method comprising the steps of:
determining, prior to pressurizing the pressure chamber (12), at least one compensation pressure portion (20, 21) in an amount of a counter pressure, which opposes movement of the clutch piston (11) into an actuation position due to fluid located in the interior space (13);
including the at least one compensation pressure portion (20, 21) in the determination of an actuating pressure (18); and
pressurizing the pressure chamber (12) with the actuating pressure (18) for transferring the clutch piston (11) into the actuation position and an associated engaging of the separating clutch (8).

17. The method according to claim 16, further comprising the step of determining a housing compensation pressure portion (20) and a dynamic pressure portion (21), of which the housing compensation pressure portion (20) corresponds to a counter pressure, which is generated during movement of the clutch piston (11) into the actuation position due to a discharge of fluid from the interior space (13), whereas, via the dynamic compensation pressure portion (21), a pressure decrease is compensated for, which is caused at a start of the pressurization of the pressure chamber (12) due to the fluid located in the interior space (13).

18. The method according to claim 17, further comprising the step of determining the dynamic compensation pressure portion (21) depending on a filling of the pressure chamber (12).

19. A computer program product for a clutch arrangement wherein a routine for determining at least one compensation pressure portion (20, 21) is implemented by appropriate control commands stored in software for operating the clutch arrangement of a hybrid transmission (1), the clutch arrangement comprising a wet separating clutch (8) having an enclosed clutch housing (10), in which a guided movable clutch piston (11) separates an interior space (13) from a pressure chamber (12), the separating clutch (8) being transferable into an engaged state, in that, with pressurization of the pressure chamber (12) with an actuating pressure (18), the clutch piston (11) moves into an actuation position, and as a result, two clutch halves, which are located in the interior space (13) and surrounded by fluid, and that otherwise are rotatable with respect to each other, are brought into contact in frictional engagement with each other, the actuating pressure (18) comprises the at least one compensation pressure portion (20, 21), which corresponds to a counter pressure depending on fluid located in the interior space (13) and opposing the clutch piston (11) during transfer into the actuation position, the clutch arrangement being operable according to a method comprising the steps of: determining, prior to pressurizing the pressure chamber (12), at least one compensation pressure portion (20, 21) in an amount of a counter pressure, which opposes the clutch piston (11) during movement thereof into an actuation position due to fluid located in the interior space (13); including the at least one compensation pressure portion (20, 21) in the determination of an actuating pressure (18); and pressurizing the pressure chamber (12) with the actuating pressure (18) for transferring the clutch piston (11) into the actuation position and an associated engaging of the separating clutch (8).

20. A data medium having a computer program product according to claim 19.
